(19) United States
(12) Patent Application Publication
(10) Pub. No.: US 2026/0167551 A1
(43) Pub. Date: Jun. 18, 2026

(54) METHOD FOR PRODUCING A PREFORM FOR AN OPTICAL FIBER

(71) Applicant: Heraeus Quarzglas GmbH & Co. KG, Hanau (DE)

(72) Inventors: Kay SCHUSTER, Bitterfeld-Wolfen (DE); Michael LORENZ, Bitterfeld-Wolfen (DE); Holger PIEL, Hanau (DE)

(21) Appl. No.: 19/421,877

(22) Filed: Dec. 16, 2025

(30) Foreign Application Priority Data
Dec. 16, 2024 (EP) 24220171.3

(51) Int. Cl. C03B 37/012; C03B 37/14

(52) U.S. Cl. CPC C03B 37/01231; C03B 37/01222; C03B 37/14; C03B 2203/40

(57) ABSTRACT

A method for producing a preform for an optical fiber, and to a preform for an optical fiber. A method for producing a preform for an optical fiber comprises producing a first bore in a first preform portion starting from a first end surface of the first preform portion, producing a second bore in a second preform portion starting from a first end surface of the second preform portion, and joining the first preform portion and the second preform portion such that the first end surface of the first preform portion and the first end surface of the second preform portion are connected to one another. This makes it possible to provide longer preforms for optical fibers while ensuring high accuracy of the bore.

### CROSS-REFERENCE TO RELATED APPLICATION

This application claims priority pursuant to 35 U.S.C. 119(a) to European Patent Application No. 24220171.3, filed Dec. 16, 2024, which application is incorporated herein by reference in its entirety.

### SUMMARY

The invention relates to a method for producing a preform for an optical fiber and to a preform for an optical fiber.

For producing optical fibers, a preform is produced first, from which optical fibers are subsequently produced. A cylinder is usually drilled to produce the preform. A core rod is subsequently inserted into the bore. It is necessary to drill very accurately in order to meet the requirements for the optical properties of the optical fiber to be produced. In order to increase the length of a preform, a plurality of preform portions can be connected or joined to one another.

So far, it is possible to drill up to a length of approximately 1.5 m with the required accuracy. In general, it is desirable to produce longer preforms. However, it is not possible to drill longer stretches using conventional methods, since the accuracy of the drilling then decreases significantly. On the one hand, as the length increases, the drill is pulled downward by gravity, which leads to a drift in the borehole. On the other hand, other effects also lead to drift. The drift can depend, for example, upon the direction of rotation of the drill, the rotational speed of the drill, and the direction of gravity.

Publication EP 3 115 344 B1 relates to a production method for a glass fiber preform in which a plurality of core preforms and a plurality of sheath preforms with through-holes are produced. The through-holes of the sheath preforms are adapted in order to produce connecting holes. Through each connecting hole, at least two of the cores preforms are inserted side by side in such a way that there is an offset between the connection points of the core preforms and the sheath preforms.

Publication U.S. Pat. No. 11,370,689 B2 discloses a vacuum method for forming a tube-based preform for optical fibers. A preform arrangement defines a sealed inner chamber to which a vacuum is applied. The arrangement is heated under vacuum until just above the softening point of the glass in order to solidify the preform.

### SUMMARY

The object of the invention is to make longer preforms for optical fibers possible while ensuring high accuracy of the drilling.

The object is achieved by the method according to claim 1 and by the preform according to claim 15. Advantageous embodiments are specified in the dependent claims.

In order to achieve the object, a method for producing a preform for an optical fiber is used. The method comprises producing a first bore in a first preform portion starting from a first end surface of the first preform portion. The method comprises producing a second bore in a second preform portion starting from a first end surface of the second preform portion. The method further comprises joining the first preform portion and the second preform portion such that the first end surface of the first preform portion and the first end surface of the second preform portion are connected to one another.

The end surfaces where the respective bore begins are connected to one another. The bore can be made with particular accuracy at the beginning. There is absolutely no influence from drill drift. The position of each bore in the cross-section of the corresponding preform portion can thus be produced very precisely. After the joining, the positions of the bores of both preform portions in the contact region of the two preform portions then match very accurately.

The method relates to the production of a preform for an optical fiber, i.e., a light guide fiber, in particular for telecommunications. It can be a core fiber with a single core or a multi-core fiber, i.e., a fiber with multiple cores. In other words, a fiber optic preform is provided. The preform is made primarily of glass, such as quartz glass.

The bore is produced by drilling, in particular using a drill. The bore is in particular a through-bore. Drilling can comprise producing a blind hole and, in particular, separating off an unbored end of the particular preform portion—for example, by sawing. In this way, a through-bore can be produced. Drilling is carried out in particular as thrust drilling, i.e., by advancing a free end of the drill into the particular preform portion. Drilling can in principle also be carried out as draw drilling.

In particular, a bore runs along the longitudinal direction of the preform portion. For example, a bore runs along the central longitudinal axis of the preform portion or parallel to the central longitudinal axis at a distance from the central longitudinal axis.

Drilling is always carried out starting from a first end surface. This means that the drilling starts at the first end surface. In particular, the drill comes into contact with the preform portion for the first time at the first end surface. In particular, the drill penetrates the first end surface and then continues to move parallel to the central longitudinal axis through the particular preform portion. In particular, drilling is carried out until the drill reaches a position before the second end surface, located on the opposite side, of the particular preform portion. In particular, the first bore in the first preform portion and the second bore in the second preform portion are arranged at corresponding positions. After the joining, this results in a continuous bore or a continuous cavity in the preform.

In particular, each preform portion is elongated. An end surface is, in particular, an end face of the particular preform portion. An end surface can, in principle, be partially or completely straight, oblique, and/or curved. Two preform portions can have the same length or different lengths. For example, one preform portion may have a length of 1,000 mm and another preform portion a length of 1,500 mm. In particular, two preform portions are identical with respect to their cross-section and/or their diameter. The diameter of the two preform portions may have slight production-related deviations, which are usually less than 0.5 mm, preferably less than 0.3 mm. This can be caused by deviations and/or tolerances in the grinding of the preform blanks. If the two preform portions are produced by dividing a preform blank, as described below, the diameters are typically identical

The order in which the first and second bores are produced is irrelevant. The two bores can be produced one after the other or, at least periodically, simultaneously. In particular, the joining is carried out subsequently.

By the joining, a preform is assembled or produced from the two preform portions. The respective first end surfaces are connected. After the joining, the second end surfaces are located on opposite sides of the preform. The resulting preform in particular has the same diameter as each individual preform portion. The length of the preform can correspond to the sum of the lengths of the individual preform portions. If the production of the preform comprises, for example, the production of a blind bore and the subsequent separating off of one end, the length of the preform may be less than the sum of the lengths of the individual preform portions. One or two non-drilled ends can be separated off prior to and/or after the joining. For example, a maximum length of 100 mm can be separated off.

In one embodiment, the first preform portion is cylindrical. In one embodiment, the second preform portion is cylindrical. The cross-section of each preform portion is accordingly identical over the entire longitudinal extent. In one embodiment, the first preform portion and/or the second preform portion is circular-cylindrical.

In one embodiment, the first preform portion and/or the second preform portion has a circular-cylindrical basic shape. The term “circular-cylindrical basic shape” means that certain deviations from the exact circular-cylindrical shape are permissible. In one example, the first preform portion and/or the second preform portion may have a circular-cylindrical basic shape but deviate from the exact circular-cylindrical shape due to a flattening. The flattening can extend over the entire length of the particular preform portion and/or be aligned parallel to the longitudinal axis. An example of flattening may be present for marking.

In another example, the first preform portion and/or the second preform portion can have a circular-cylindrical basic shape, but have one or two oblique end surfaces. Oblique end surfaces can be produced, for example, when a preform blank is divided—for example, during sawing. The pressure acting upon the saw blade can cause the saw blade to deflect by a few degrees.

A preform portion can be solid or at least partially hollow. When producing a bore, one or more bores may already be present in a preform portion, wherein the one or more bores in particular run parallel to the central longitudinal axis. In one embodiment, the first and/or the second preform portion is a hollow cylinder with a central bore along the central longitudinal axis.

In one embodiment, the first preform portion and/or the second preform portion is oriented substantially horizontally during drilling, i.e., during the production of the first bore and/or of the second bore. Horizontal drilling requires a significantly lower room height and is therefore usually easier to implement. The joining according to the invention allows maximum accuracy to be achieved, despite the increased drift during horizontal drilling.

In one embodiment, the joining is carried out by welding. During welding, at least in the region of the joint, the temperature of the preform portions to be joined is increased such that a bonded connection is produced. For example, heating can be carried out up to above the glass transition temperature. It has been shown that welding is a particularly advantageous way to achieve the object.

In a further embodiment, the method comprises dividing a preform blank to produce the first preform portion and the second preform portion. In other words, the preform portions are produced, viz., by dividing a preform blank, before the bores are made.

Dividing means a mechanical separation. For example, dividing is carried out by a separation method. In particular, dividing is carried out approximately transversely to the longitudinal extent of the preform blank, preferably at an angle of 90° to the central longitudinal axis.

Dividing thus produces preform portions from a preform blank, which preform portions are drilled and subsequently re-assembled to form a preform.

In one embodiment, the dividing is carried out with a saw, in particular with a circular saw. It has been found that sawing, in particular with a circular saw, is a particularly suitable method for dividing the preform blank.

In a further embodiment, the end surfaces produced during the dividing are the first end surface of the first preform portion and the first end surface of the second preform portion.

When dividing, two new end surfaces are created. In this embodiment, these new end surfaces correspond to the end surfaces to be subsequently joined. In other words, after the drilling, the two preform portions are connected again at the surfaces where they were originally connected to one another. In this way, the material structure of the preform portions or of the produced preform largely corresponds to the material structure of the preform blank. Furthermore, the produced end surfaces fit together particularly well. This has proven to be particularly advantageous for achieving the object. In particular in the case of hollow cylinders, an offset of the center bore is avoided.

In a further embodiment, the joining is carried out such that a relative angular position of the first preform portion and of the second preform portion in relation to a longitudinal axis corresponds to the relative angular position of the first preform portion and of the second preform portion in the preform blank. In other words, the joining is carried out such that the angular position in relation to the central longitudinal axis is the same after the joining as it was prior to the dividing. Typically, the first preform portion and/or the second preform portion is rotated along the respective longitudinal axis until the desired angular position is set. The longitudinal axis is, in particular, a common longitudinal axis of the two preform portions prior to the joining, which accordingly corresponds to the longitudinal axis of the preform after the joining.

In this way, any angle that deviates from 90° can be compensated for during the dividing. This particularly advantageously ensures high accuracy. This embodiment can prevent any resulting gap or kink in the preform.

In one embodiment, a marking is applied prior to the dividing. The marking is applied to the preform blank. This is carried out such that, prior to the joining, the relative angular position of the first preform portion and of the second preform portion can be set on the basis of the marking. The marking is applied in particular to the lateral surface of the preform blank.

The marking can be applied to the outside of the preform blank. For example, a line, in particular a thin line, can be applied, preferably parallel to the longitudinal axis, in the region of the point intended for dividing. When dividing, the line is also divided in this case. Prior to the joining, the two parts of the line can then be aligned with one another. This makes it particularly easy to restore the original angular position of the preform portions. This ensures a particularly high level of accuracy.

Alternatively or additionally, a marking can be applied inside the preform blank. For example, a marker bore can be made—for example, parallel to the longitudinal axis of the preform blank at a distance from the longitudinal axis. The marker bore is thus applied at a position that breaks rotational symmetry. In this way, prior to the joining, the angular position of the two preform portions can be set on the basis of such a marker bore. A marker rod that has a refractive index different from that of the preform blank can be inserted into the marker bore. A marking inside the preform blank can be produced with minimal technical effort, since the requirements for the precision of the position of the marker bore along the axis of the particular preform blank are significantly lower than for the main bores in the preform portions. A marking inside the preform blank can also be used to mark the cores in the produced fiber.

In particular, prior to the joining, the relative angular position of the first preform portion and of the second preform portion is set on the basis of the marking. The marker can also be used to set the angular position when drilling.

In particular, before the first and/or second bore is produced, the drill and the preform portion are aligned in relation to the central longitudinal axis such that the bore is produced in a defined angular position in relation to the longitudinal axis in the cross-section of the particular preform portion. This ensures that the one or more eccentric bores are made at corresponding positions.

In one embodiment, the preform is used for a multi-core fiber. In particular, a plurality of first bores is made starting from the first end surface of the first preform portion. In particular, a plurality of second bores are made starting from the first end surface of the second preform portion. In particular, the first bores are parallel to one another and/or to the longitudinal axis of the first preform portion. In particular, the second bores are parallel to one another and/or to the longitudinal axis of the first preform portion.

A multi-core fiber is a core fiber with a plurality of cores. The specific number of cores is irrelevant to the method. For example, the multi-core fiber can have two, four, or more cores.

In particular, the number of first bores corresponds to the number of second bores. In particular, the first bores in the first preform portion and the second bores in the second preform portion are arranged at corresponding positions. This means that, after the joining, there are continuous bores that extend over the entire length of the preform.

In one embodiment, the preform has a length of more than 1.5 m, in particular at least 2.0 m. The length can be at least 2.5 m, in particular approximately 3.0 m. Using current methods, it is not possible to produce a preform of this length with the required accuracy.

In one embodiment, the first preform portion and/or the second preform portion has a maximum length of 1.5 m. The length can be at most 1.25 m or 1.0 m. The length can be at least 0.5 m or 0.75 m. For example, both preform portions are the same length. In order to achieve maximum accuracy, such a length has proven particularly advantageous.

In a further embodiment, a ratio of a length of the preform to a diameter of the first bore and/or of the second bore is greater than 35, in particular greater than 50. As the ratio of the length of the preform to the diameter of the bore increases, the drift also increases, which counteracts the required accuracy. The solution according to the invention makes such ratios possible with high accuracy.

Another aspect of the invention is a preform for an optical fiber, in particular for a multi-core fiber. The preform can be produced or is produced using the method according to the invention. A ratio of the length of the preform to a diameter of the first bore and/or of the second bore is greater than 35, in particular greater than 50. Alternatively or additionally, the length of the preform is more than 1.5 m, in particular at least 2.0 m. Such a preform cannot be produced using conventional methods. All the advantages, features, and embodiments of the method described above can apply analogously to the preform, and vice versa.

Exemplary embodiments of the invention are also explained in greater detail below with reference to figures. Features of the exemplary embodiments can be combined individually or in a plurality with the claimed subject matter, unless otherwise indicated. The claimed scope of protection is not limited to the exemplary embodiments.

### BRIEF DESCRIPTION OF THE DRAWINGS

The figures show:

FIGS. 1 and 2 show cross-sectional drawings of preforms;

FIG. 3 shows a schematic representation of a drilling process;

FIG. 4 shows a schematic representation of a preform portion;

FIGS. 5 and 6 show schematic representations of method steps for producing a preform;

FIGS. 7 to 9 show schematic representations of other method steps for producing a preform;

FIGS. 10 to 12 show schematic representations of method steps during the production of preform portions; and,

FIG. 13 shows a cross-sectional drawing of a preform blank with a marking.

### DETAILED DESCRIPTION OF THE INVENTION

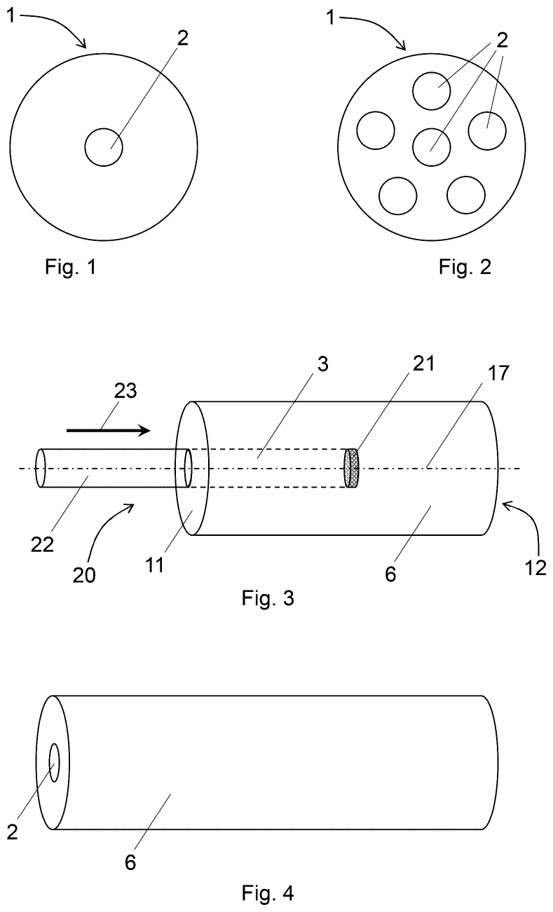

FIGS. 1 and 2 show, by way of example, cross-sections of different preforms 1 that can be produced according to the invention. The preforms each have a circular cross-section. The preforms 1 typically have a central bore 2 that runs along the central longitudinal axis of the particular preform 1. Each bore 2 can be composed of first bores or second bores of the corresponding preform portions.

FIG. 2 shows, by way of example, five eccentric bores 2 in addition to the optional central bore 2. These eccentric bores are, for example, regularly distributed on a circle, which can be arranged concentrically with the outer contour of the preform 1.

FIG. 3 schematically shows a drilling method for producing a bore 3 in a first preform portion 6. A drill 20 is moved along a direction 23 parallel to the longitudinal axis 17 of the preform portion 6 and rotates in particular about its longitudinal axis. The drill 20 typically comprises a drill head 21, which is driven by a drill rod 22. These components are shown here purely schematically; usually, the drill rod 22 has a smaller diameter than the drill head 21. The drill rod 22 is driven, for example, by a drive unit not shown.

It is evident that the drill 20 has penetrated the first preform portion 6 at the first end surface 11 and from there produces the first bore 3. The first bore 3 is shown here, purely by way of example, as a central bore.

FIG. 4 shows the first preform portion 6 prepared in this way, with the first bore 3. What is shown in FIGS. 3 and 4 and described above applies analogously to a bore 4 in a second preform portion 7.

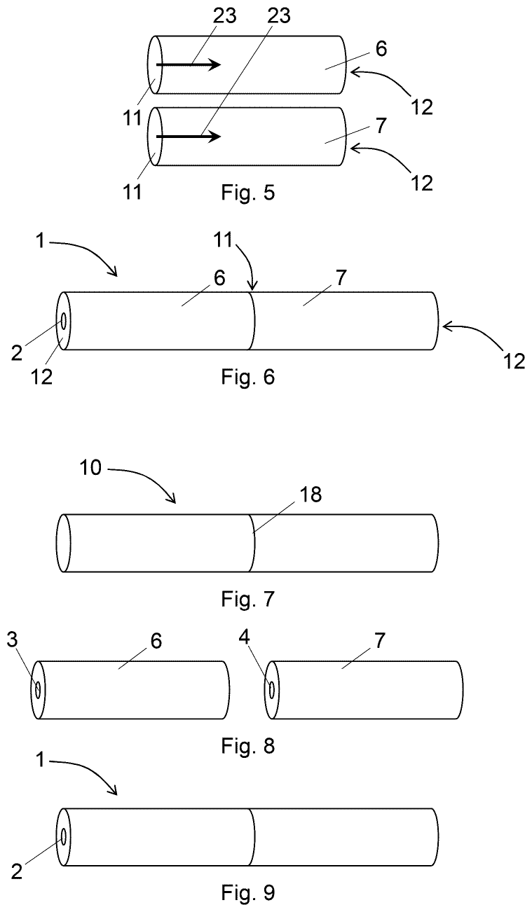

FIG. 5 schematically shows the production of a first bore in a first preform portion 6, starting from the first end surface 11, and the production of a second bore in a second preform portion 7, starting from the first end surface 11. Arrow 23 indicates the direction of movement of the particular drill. The corresponding second end surface 12 is arranged on the opposite end face of the particular preform portion 7, 8.

FIG. 6 shows the subsequent joining of the thus prepared preform portions 6, 7 in order to produce the preform 1. The preform portions 6, 7 have been positioned relative to one another such that the first end surfaces 11 face one another and are in contact with one another. Typically, at least one preform portion has been rotated about an axis that runs perpendicular to its longitudinal axis, for example. This may have occurred, for example, after the bore has been produced in the relevant preform portion. The two preform portions 6, 7 are now joined in this alignment. The longitudinal axes of the two preform portions 6, 7 coincide and correspond to the longitudinal axis of the preform thus produced.

The second end surfaces 12 are thus located on the opposite outer end faces. The joining of the first end surfaces 11, where the position of the corresponding bore 3, 4 is precisely defined in relation to the cross-section and is not subject to any drift, ensures very good accuracy. In this way, a preform 1 with a length of, for example, 3 m can be produced. In particular, the preform portions 6 and 7 are welded together.

FIGS. 7 to 9 show further method steps for producing the preform. As shown in FIG. 7, a preform blank 10 is divided at a division position 18—for example, by sawing. This produces the first preform portion 6 and the second preform portion 7. The drilling is subsequently carried out, e.g., according to FIGS. 5 and/or 3. FIG. 8 shows the subsequent situation, in which the preform portions 6, 7 have been provided with respective bores 3, 4 and can be joined. After the joining, as shown in FIG. 9, a preform with a continuous bore 2 is present.

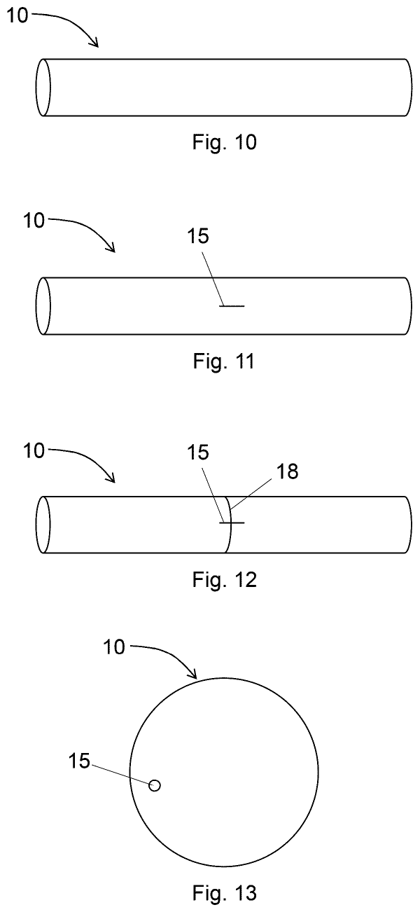

FIGS. 10 to 12 show further method steps for dividing the preform blank 10. First, as shown in FIG. 15, a marking 15 is applied to the outside of the preform blank 10. The marking 15 is shown here, by way of example, as an axially aligned line. The marking 15 extends over both sides of the preform blank 10, as shown in FIG. 12 by the marked division position 18. The marking 15 allows the original relative angular position of the preform portions 6, 7 in the preform blank to be restored after the dividing and drilling and prior to the joining.

FIG. 13 shows a cross-section of a preform blank 10. This blank has, as a marking 15, an eccentric marker bore inside it. The marker bore runs parallel to the central longitudinal axis of the preform blank 10 at a distance therefrom. The marker bore can be produced, as shown in FIGS. 11 and 12 and described above, prior to the dividing and can be used for the relative alignment of the preform portions 6, 7 prior to the joining.

In one embodiment, the preform is assembled or is composed of exactly two preform portions. In the case of more than two preform portions, an end surface where a bore does not start must always be connected. As a result, the advantage according to the invention, viz., that the bores in the end surfaces to be joined match exactly, cannot be achieved throughout. In contrast, if the preform contains exactly two preform portions, the exact match can be fully ensured.

Experiments were conducted in order to assess the quality of the preform on the basis of deviations between the hole positions on the joined end surfaces of two preform portions. For this purpose, preforms were produced, taking into account all the different possibilities when joining two preform portions. The first end surface, from which the particular bore starts, i.e., the entry side of the drill, is denoted by a. The second end surface, where the particular bore ends, i.e., the exit side of the drill, is denoted by b. The position of the bore on this side is affected by the drift of the drill. The first preform portion is denoted by 1, and the second preform portion is denoted by 2. The results are summarized in the following table:

| | 1a | 1b |
|---|---|---|
| 2a | ++ | − |
| 2b | − | −− |

Table: Quality of the preforms on the basis of deviations in the hole position. Legend: ++ acceptable deviation, − unacceptable deviation, −− maximum and unacceptable deviation

It is evident that the method according to the invention, in which the first end surface of the first preform portion (1a) and the first end surface of the second preform portion (2a) are joined to one another (1a-2a), provides an acceptable hole position and thus the preferred result. In contrast, larger, unacceptable deviations were found in the cases 1a-2b and 1b-2a, where a first end surface (entry side) was connected to a second end surface (exit side). The largest, and also unacceptable, deviations were found in the case 1b-2b, in which the two second end surfaces or exit sides were connected to one another. It is evident that only one of four possibilities leads to the desired result.

In one embodiment, a marking is created on the first preform portion. The marking can be created before or after the first bore is produced, preferably before. In one embodiment, a marking is created on the second preform portion. The marking can be created in the second preform portion before or after the second bore is produced, preferably before. The marking can be used to identify the side where the particular first end surface is located. In this way, it can be ensured during the joining that the first end surface or the second end surface is joined. The marking can include an orientation that indicates an angular position of the preform portions. This prevents an offset after optionally dividing a preform blank, if the end surfaces are not aligned exactly perpendicular to the longitudinal extent of the preform blank.

The marking can be any marking that is in particular visible on the outside of the particular preform portion. The marking can be temporary or permanent. In principle, the marking can be applied at any point of the particular preform portion and/or have any shape or design, as long as its shape and/or position makes it suitable for directly or indirectly identifying the side of the first end surface. In particular, the marking should not be mirror-symmetrical with respect to a plane that is centered with respect to the longitudinal extent of the particular preform portion and runs perpendicular to the longitudinal extent direction. The above statements regarding the marking applied before the dividing can also apply to the marking described here, and vice versa.

### LIST OF REFERENCE SIGNS

1 Preform
2 Bore
3 First bore
4 Second bore
6 First preform portion
7 Second preform portion
10 Preform blank
11 First end surface
12 Second end surface
15 Marking
17 Longitudinal axis
18 Division position
20 Drill
21 Drill head
22 Drill rod
23 Direction

What is claimed is:

1. A method for producing a preform for an optical fiber, comprising:
producing a first bore in a first preform portion starting from a first end surface of the first preform portion;
producing a second bore in a second preform portion starting from a first end surface of the second preform portion; and,
joining the first preform portion and the second preform portion such that the first end surface of the first preform portion and the first end surface of the second preform portion are connected to one another.

2. The method according to claim 1, wherein the first preform portion and/or the second preform portion are cylindrical.

3. The method according to claim 1, wherein the first preform portion and/or the second preform portion has a circular-cylindrical basic shape.

4. The method according to claim 3, wherein the first preform portion and/or the second preform portion is oriented substantially horizontally during drilling.

5. The method according to claim 1, wherein the joining is carried out by welding.

6. The method according to claim 1, wherein the method further comprises:
dividing a preform blank to produce the first preform portion and the second preform portion.

7. The method according to claim 6, wherein the dividing is carried out with a saw, in particular with a circular saw.

8. The method according to claim 6, wherein the end surfaces produced during the dividing are the first end surface of the first preform portion and the first end surface of the second preform portion.

9. The method according to claim 8, wherein the joining is carried out such that a relative angular position of the first preform portion and the second preform portion in relation to a longitudinal axis corresponds to the relative angular position of the first preform portion and the second preform portion in the preform blank.

10. The method according to claim 9, wherein prior to the dividing a marking is applied such that prior to the joining the relative angular position of the first preform portion and the second preform portion can be adjusted on the basis of the marking.

11. The method according to claim 1, wherein the preform is used for a multi-core fiber, wherein a plurality of first bores are made starting from the first end surface of the first preform portion, wherein a plurality of second bores are made starting from the first end surface of the second preform portion.

12. The method according to claim 1, wherein the preform has a length of more than 1.5 m, in particular at least 2.0 m.

13. The method according to claim 1, wherein the first preform portion and/or the second preform portion has a maximum length of 1.5 m.

14. The method according to claim 1, wherein a ratio of a length of the preform to a diameter of the first bore and/or the second bore is greater than 35, in particular greater than 50.

15. A preform for an optical fiber, in particular for a multi-core fiber, that can be produced by the method according to claim 1, wherein
a ratio of a length of the preform to a diameter of the first bore and/or the second bore is greater than 35, in particular greater than 50; and/or,
a length of the preform is more than 1.5 m, in particular at least 2.0 m.

16. The method according to claim 2, wherein the first preform portion and/or the second preform portion has a circular-cylindrical basic shape.

17. The method according to claim 2, wherein the joining is carried out by welding.

18. The method according to claim 3, wherein the joining is carried out by welding.

19. The method according to claim 4, wherein the joining is carried out by welding.

20. The method according to claim 7, wherein the end surfaces produced during the dividing are the first end surface of the first preform portion and the first end surface of the second preform portion.
